(19) United States
(12) Patent Application Publication
(10) Pub. No.: US 2011/0185237 A1
(43) Pub. Date: Jul. 28, 2011

(54) System and Method for Delivering Messages

(75) Inventors: Kaniz Mahdi, Carrollton, TX (US); Shufeng Shi, Xi'an (CN)

(73) Assignee: FutureWei Technologies, Inc., Plano, TX (US)

(21) Appl. No.: 13/016,619

(22) Filed: Jan. 28, 2011

Related U.S. Application Data
(60) Provisional application No. 61/299,246, filed on Jan. 28, 2010.

(51) Int. Cl. G06F 11/07; G06F 15/16

(52) U.S. Cl. 714/49; 709/206; 714/E11.021

(57) ABSTRACT

A system and method for delivering messages are provided. A method for communications device operations includes detecting a failure in a delivery of a message to a first recipient device, determining a second recipient device for the message, and initiating a redelivery of the message to the second recipient device. The first recipient device is formerly registered in a first domain of a communications network or is unavailable in the first domain.

This application claims the benefit of U.S. Provisional Application No. 61/299,246, filed Jan. 28, 2010, entitled “System and Method for Enabling Delivery of SMS to Multiple Devices Via Multiple Access Networks,” which application is hereby incorporated herein by reference.

### TECHNICAL FIELD

The present invention relates generally to wireless communications, and more particularly to a system and method for delivering messages.

### BACKGROUND

Wireless communications devices have provided unprecedented mobility and have therefore revolutionized how users work and play. Wireless communications devices allow users to access information substantially wherever they go without having to worry about making special arrangements in order to access information.

However, mobility may introduce problems. For example, due to a user's mobility, the user's wireless communications device may leave a service area of a domain or access network. Once out of the service area of the domain or access network, it may become difficult to send messages, such as short messages, to the wireless communications device. For example, messages intended for the user of the wireless communications device may be undeliverable while the wireless communications device is not operating in the service area of the domain or access network. Thereby, keeping potentially important information from the user.

A prior art technique may involve the retransmission of a message to the wireless communications device upon a failure to deliver the message due to the wireless communications device leaving the service area of its domain or access network once the wireless communications device returns to the domain or access network. However, the wireless communications device may be away from the domain or the access network for an extended amount of time. Therefore, there is a need to deliver messages to the user as soon as possible.

### SUMMARY OF THE INVENTION

These and other problems are generally solved or circumvented, and technical advantages are generally achieved, by example embodiments of the present invention which provide a system and method for delivering messages.

In accordance with an example embodiment of the present invention, a method for communications device operations is provided. The method includes: detecting a failure in a delivery of a message to a first recipient device; determining a second recipient device for the message; and initiating a redelivery of the message to the second recipient device. The first recipient device is formerly registered in a first domain of a communications network or is unavailable in the first domain.

In accordance with another example embodiment of the present invention, a method for communications device operations is provided. The method includes: detecting a failure in a delivery of a message to a first recipient device; receiving an alternate message to be delivered to a second recipient device; establishing a route path to the second recipient device; and forwarding the alternate message to the second recipient device over the route path. The first recipient device is formerly registered in a first domain of a communications network or is unavailable in the first domain.

In accordance with another example embodiment of the present invention, a communications device is provided. The communications device includes: a failure detect unit; a recipient detect unit coupled to the failure detect unit; and a delivery initiate unit coupled to the recipient detect unit. The failure detect unit detects a failure in a delivery of a message to a first recipient device, where the first recipient device is formerly registered in a first domain of a communications network or is unavailable in the first domain; the recipient detect unit detects a second recipient device for the message; and the delivery initiate unit initiates a redelivery of the message to the second recipient device.

In accordance with another example embodiment of the present invention, a communications device is provided. The communications device includes: a failure detect unit; a message transfer unit coupled to the failure detect unit; a message route unit coupled to the message transfer unit; and a message forward unit coupled to the message route unit and to the message transfer unit. The failure detect unit detects a failure in a delivery of a message to a first recipient device, where the first recipient device is formerly registered in a first domain of a communications network or is unavailable in the first domain; the message transfer unit receives an alternate message to be delivered to a second recipient device; the message route unit establishes a route path to the second recipient device; and the message forward unit forwards the alternate message to the second recipient device over the route path.

One advantage disclosed herein is that a message may be delivered to a wireless communications device as soon as it registers with an alternate domain or access system instead of waiting for the wireless communications device to register back with an original domain or access system wherein the failed message delivery attempt occurred. Delivery to the alternate domain or access system may allow for quicker delivery of the message to the wireless communications device.

A further advantage of exemplary embodiments is that a message may be delivered to an alternate wireless communications device of the user if the message is undeliverable to a preferred wireless communications device. Delivery to the alternate wireless communications system may allow for quicker delivery of the message to the user.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example diagram of a communications network;

FIG. 2 illustrates an example diagram of a general architecture of a communications network;

FIG. 3 illustrates an example diagram of a message sequence flow in a delivery of a message to a UE operating in a communications network wherein UE changes domain;

FIG. 4a illustrates an example diagram of a message flow occurring in a communications network for the delivery of a message to a UE that changes domains;

FIG. 4b illustrates an example flow diagram of operations occurring in a HSS for the delivery of a message to a UE that changes domains;

FIG. 4c illustrates an example flow diagram of operations occurring in a SMS-GMSC for the delivery of a message to a UE that changes domains;

FIG. 5 illustrates an example diagram of a message sequence flow in a delivery of a message to an alternate UE of a user operating in a communications network;

FIG. 6a illustrates an example diagram of a message flow occurring in a communications network for the delivery of a message to an alternate UE of a user operating in a communications network;

FIG. 6b illustrates an example flow diagram of operations occurring in a HSS for the delivery of a message to an alternate UE of a user operating in a communications network;

FIG. 6c illustrates an example flow diagram of operations occurring in a SMS for the delivery of a message to an alternate UE of a user operating in a communications network;

FIG. 7 illustrates an example diagram of a communications device; and

FIG. 8 illustrates an example diagram of a communications device.

### DETAILED DESCRIPTION OF ILLUSTRATIVE EMBODIMENTS

The making and using of the presently example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a communications network that includes a number of domains and/or access networks and supports short message service (SMS). The invention may also be applied, however, to other communications networks with multiple domains and/or access networks that support other forms of messaging service.

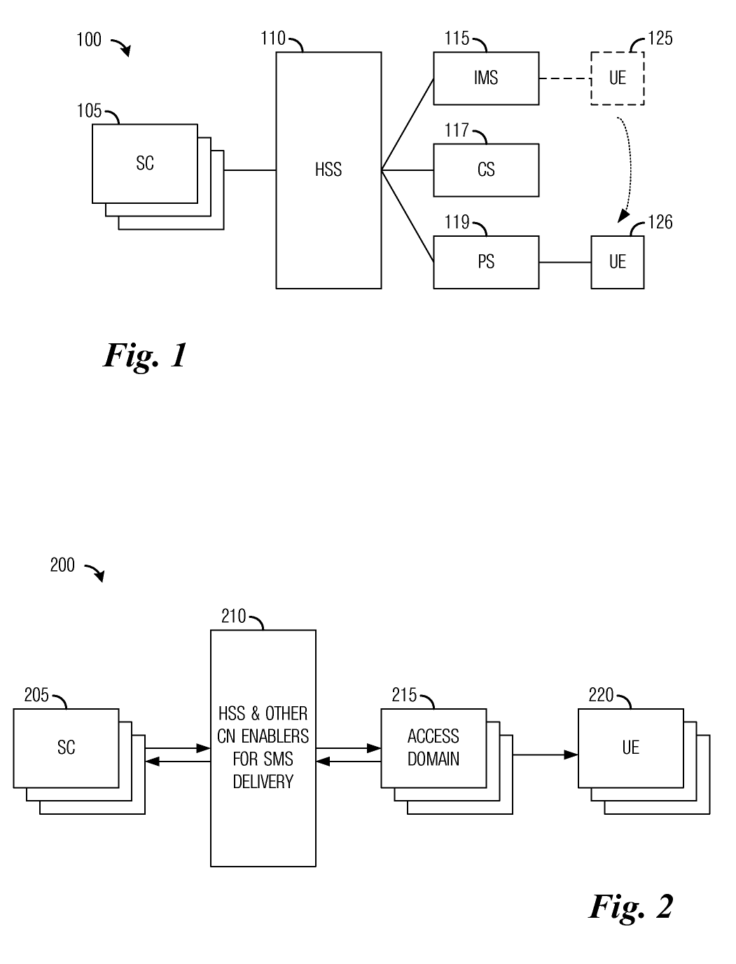

FIG. 1 illustrates a communications network 100. Communications network 100 includes multiple service controllers (SC) 105 coupled to a home subscriber server (HSS) 110. HSS may be a master database that supports Internet Protocol (IP) Multimedia System (IMS) entities that handle connections. HSS 110 may contain subscriber profiles, perform authentication and authorization, provide user location information, provide IP information, and so forth.

HSS 110 is in turn coupled to multiple domains, such as IMS domain 115, Circuit Switched (CS) domain 117, Packet Switched (PS) domain 119, and so forth. Communications network 100 also includes User Equipment (UE), which may be connected to one domain at a time. However, due to mobility, UE may change domains. For example, UE 125 may change from IMS domain 115 to PS domain 119 (shown as UE 126 to differentiate the same UE connected to different domains, for example, UE 125 connected to IMS domain 115).

Generally, messages, such as short messages, intended for a UE that is operating in a first domain is not deliverable to the UE if the UE is no longer operating in the first domain or has moved to a second domain. Therefore, a usual solution is to wait for the UE to return to the first domain in order to deliver the messages. However, it may take a long time (if ever) for the UE to return to the first domain and the messages may be time critical. Therefore, there is a need to deliver the messages as quickly as possible.

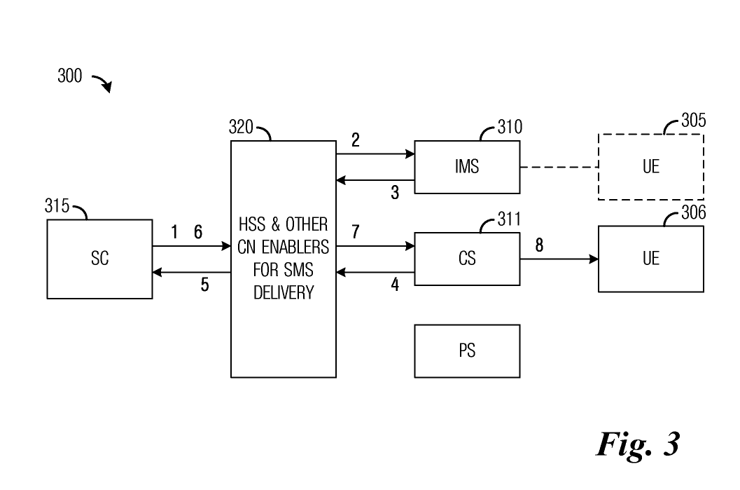

FIG. 2 illustrates a general architecture of a communications network 200. Communications network 200 includes one or more SC 205 coupled to an HSS 210. As shown in FIG. 2, HSS 210 may also include other core network (CN) enablers that may be used for short message delivery. Also shown as a single entity, HSS 210 and other CN enablers may be implemented as separate entities or combinations of entities.

Coupled to HSS 210 may be one or more access domains 215, such as IMS domain, CS domain, PS domain, and so forth. One or more UEs 220 may be coupled to access domains 215. Some UEs may be capable of switching domains, while some may not be capable of switching domains. Furthermore, some UEs may be simultaneously coupled to more than one domain; however, usually one UE is coupled to only one domain at a given time.

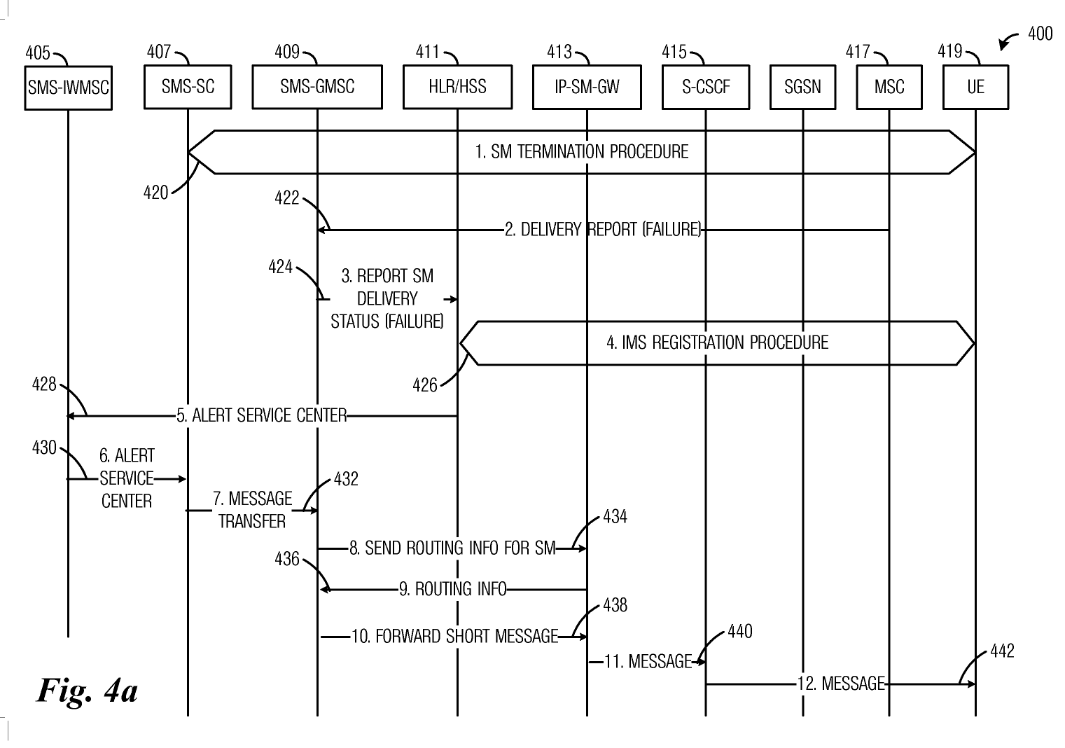

FIG. 3 illustrates a message sequence flow 300 in a delivery of a message to a UE operating in a communications network wherein UE changes domain. As shown in FIG. 3, the UE is shown originally operating in IMS domain 310 (when connected to IMS domain 310, the UE is shown as UE 305) and later, the UE disconnects from IMS domain 310 to CS domain 311 (when connected to CS domain 311, the UE is shown as UE 306. Although shown with two different reference numerals, UE 305 and UE 306 represent the same UE at different time instances. To further illustrate the time difference, UE 305 is shown using a dashed line.

While the UE (UE 305) is connected to IMS domain 310, SC 310 attempts to deliver a message to the UE (shown in FIG. 3 as event 1). SC 310 attempts to deliver the message to the UE by sending the message to HSS 320, which knows the domain of the UE (i.e., IMS domain 310) and forwards the message to IMS domain 310 (shown as event 2).

However, by the time the message gets to IMS domain 310, the UE has disconnected or otherwise become unreachable. Therefore, IMS domain 310 responds with a response indicating delivery failure (shown as event 3). According to an embodiment, the response from IMS domain 310 to HSS 320 may include information that notifies HSS 320 that the UE is missing, e.g., “absent subscriber.”

At some later time, the UE connects back to the communications network. However, this time, the UE connects through CS domain 311 and is shown in FIG. 3 as UE 306. When the UE connects to CS domain 311, CS domain 311 may send a report to HSS 320 that the UE has become available, e.g., through a new Visitor Location Registration (VLR) registration (shown as event 4). After receiving the report from CS domain 311, HSS 320 may alert SC 315 that the UE is now available (shown as event 5). According to an embodiment, in addition to alerting SC 315, HSS 320 may also alert other SCs in a Message Waiting Data (MWD) list that are also interested in the UE.

After being alerted by HSS 320, SC 315 may reattempt to deliver the message to the UE (shown as event 6). SC 315 may make use of information related to the UE provided by HSS 320 to deliver the message to the UE in CS domain 311. HSS 320 may forward the message to CS domain 311 for deliver to the UE (shown as event 7). CS domain 311 is able to successfully deliver the message to the UE (shown as event 8).

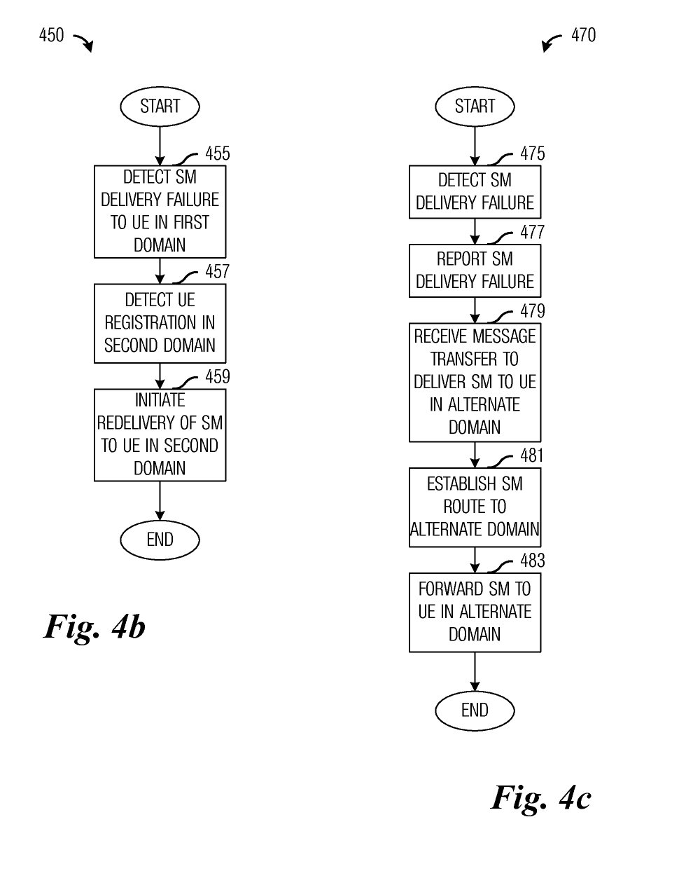

FIG. 4a illustrates a message flow 400 occurring in a communications network for the delivery of a message to a UE that changes domains. Message flow 400 illustrates messages exchanged between various entities in the communications network involved in the delivery of a message to a UE that changes domains between an initiation of a message delivery to the UE prior to the UE disconnecting from a first domain until when the message is finally delivered to the UE. Message flow 400 involves entities: Interworking MSC For Short Message Service (SMS-IWMSC) 405, SMS service center (SMS-SC) 407, Gateway MSC For Short Message Service (SMS-GMSC) 409, HLR/HSS 411, IP-Short-Message-Gateway (IP-SM-GW) 413, serving call session control function (S-CSCF) 415, Mobile Switch Center (MSC) 417, and User Equipment (UE) 419.

Message flow 400 may begin with SMS-SC 407, SMS-GMSC 409, HLR/HSS 411, MSC 417 and UE 419 participating in a short message termination procedure (event 420). According to an embodiment, MSC 417 incorporates the functionality of the Visited Location Register (VLR) and may be referred to as a mobility controller. The short message termination procedure may be a result of a failure in a delivery of a message to UE 419 in the first domain. The failure in the delivery of the message may be the result of UE 419 disconnecting from the first domain or otherwise becoming unavailable. Since UE 419 has disconnected from the first domain, attempts to deliver messages to UE 419 in the first domain will fail. MSC 417 may report to SMS-GMSC 409 that a message deliver attempt to UE 419 has failed (event 422). After receiving the message delivery attempt failure from MSC 417, SMS-GMSC 409 may also report the failure of the message delivery attempt to HLR/HSS 411 (event 424).

At a later time, UE 419 and HLR/HSS 411 may participate in an IMS registration procedure when UE 419 reappears in the communications network (event 426). With UE 419 registered in the communications network, HLR/HSS 411 may alert SMS-IWMSC 405 that there is pending message for UE 419 (event 428). Furthermore, SMS-IWMSC 405 may in turn alert SMS-SC 407 that UE 419 has reregistered with the communications network (event 430). SMS-SC 407, which may be storing the pending message, may forward the pending message to SMS-GMSC 409 (event 432).

SMS-GMSC 409 may send to HSS/HLR 411 a request for routing information for the message to UE 419 and the HSS/HLR 411 may forward the request to the IP-SM-GW 413 (event 434), and IP-SM-GW 413 may respond with the address of itself as the routing information (event 436). SMS-GMSC 409 may then forward the message to IP-SM-GW 413 (event 438). IP-SM-GW 413 may then send the message to S-CSCF 415 (event 440), which will ultimately deliver the message to UE 419 (event 442).

FIG. 4b illustrates a flow diagram of operations 450 occurring in a HSS for the delivery of a message to a UE that changes domains. Operations 450 may be indicative of operations occurring in a HSS (or HLR/HSS) of a communications network as a message is delivered to a UE that has changed domains. Operations 450 may occur while the HSS is in a normal operating mode.

Operations 450 may begin with the HSS detecting a failure in the delivery of a message to the UE that was formerly connected to a first domain (block 455). According to an embodiment, the HSS may detect the failure in the delivery of the message due to a report sent to the HSS from a SMS-GMSC or IP-SM-GW. The report may be sent by the SMS-GMSC or IP-SM-GW after it has attempted to deliver the message to the UE, but has found that the UE is no longer operating in the first domain.

The HSS may at a later time participate with the UE in an IMS registration procedure (block 457). The UE and the HSS may participate in the IMS registration procedure as the UE reenters the communications network, but the UE may enter the communications network through a second domain. Although the discussion focuses on the UE reentering the communications network at the second domain, which may be different from the first domain. However, the UE may reenter the communications network at the second domain with the second domain being the same as the first domain.

The HSS may then initiate a redelivery of the message to the UE in the second domain (block 459). According to an embodiment, initiating the redelivery of the message may involve the HSS sending updated information about the UE, such as with domain information in which the UE is operating and/or the address of the second domain where the message is to be routed, to a SMS-IWMSC, such as SMS-IWMSC 405 of FIG. 4a. The updated information may then cause the SMS-IWMSC to attempt to redeliver the message. Wherein after, operations 450 may terminate.

FIG. 4c illustrates a flow diagram of operations 470 occurring in a SMS-GMSC or IP-SM-GW for the delivery of a message to a UE that changes domains. Operations 470 may be indicative of operations occurring in a SMS-GMSC or IP-SM-GW of a communications network as a message is delivered to a UE that has changed domains. Operations 470 may occur while the SMS-GMSC or IP-SM-GW is in a normal operating mode.

Operations 470 may begin with the SMS-GMSC or IP-SM-GW detecting a failure in the delivery of a message to the UE (block 475). According to an embodiment, the SMS-GMSC or IP-SM-GW may detect the failure based on messages exchanged while the UE and the SMS-SC is participating in a SM termination procedure, which may be the result of a failed message delivery attempt to the UE. A MSC or SGSN or S-CSCF may send reports of the delivery failure to the SMS-GMSC or IP-SM-GW, and the SMS-GMSC or IP-SM-GW may then send reports of the delivery failure to the HSS (block 477).

At a later time, when the UE has reregistered in the communications network, the SMS-GMSC or IP-SM-GW may receive a message transfer that contains the failed message (block 479). Additionally, the message transfer may include information about which domain the UE is operating in, for example, a second domain, which may or may not be the same as the first domain. The SMS-GMSC or IP-SM-GW may then establish a route to the UE in the second domain (block 481) and forward the message to the UE in the second domain (block 483). Wherein after, operations 470 may terminate.

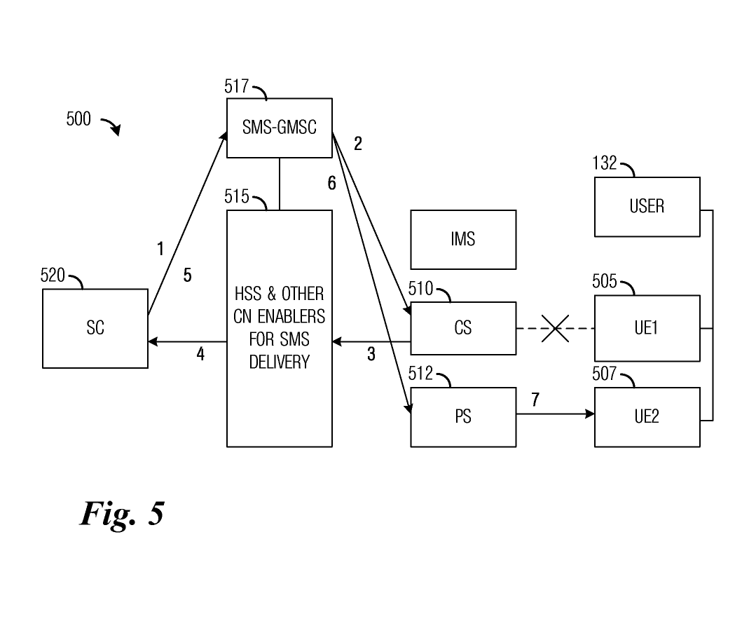

FIG. 5 illustrates a message sequence flow 500 in a delivery of a message to an alternate UE of a user operating in a communications network. As shown in FIG. 5, a user may have multiple UEs, e.g., UE1 505 that is connected to CS domain 510 and UE2 507 that is connected to PS domain 512. Although the UEs of the user are shown as being connected to different domains, multiple UEs of the user may be connected to the same domain. Furthermore, UE1 505 is shown in FIG. 5 as being disconnected from CS domain 510.

While it is preferred that a message be delivered to its intended user at its intended UE, it may be better to deliver the message to an alternate UE of the user if the intended UE of the user is not available rather than not delivering the message to the user at all or forcing the message to be held for an extended amount of time.

For discussion purposes, let UE1 505 be the intended destination for a message. While UE1 505 is connected to CS domain 510, SC 520 attempts to deliver the message to UE1 505 (shown in FIG. 5 as event 1). SC 520 attempts to deliver the message to UE1 505 by sending the message to SMS-GMSC 517, and then SMS-GMSC 517 forwards the message to CS domain 510 (shown as event 2) after getting routing information from the HSS 515, which knows the domain of UE1 505 (i.e., CS domain 510).

However, by the time the message gets to CS domain 510, UE1 505 has disconnected or otherwise become unreachable. Therefore, CS domain 510 responds with a response indicating delivery failure (shown as event 3). According to an embodiment, the response from CS domain 510 to HSS 515 may include information that notifies HSS 515 that UE1 505 is missing, e.g., “absent subscriber.”

However, HSS 515 knows that the user also has another UE (UE2 507) that is connected to PS domain 512. HSS 515 may alert SC 520 that UE2 507 is an alternate UE of the user and is available (shown as even 4). According to an embodiment, in addition to alerting SC 520, HSS 515 may also alert other SCs in a Message Waiting Data (MWD) list that are also interested in the user.

After being alerted by HSS 515, SC 520 may reattempt to deliver the message to UE2 507 (shown as event 5). SC 520 may make use of information related to UE2 507 provided by HSS 515 to deliver the message to UE2 507 in PS domain 512.

The message may be routed to SMS-GMSC 517 (shown as event 5), and then SMS-GMSC 517 may forward the message directly to PS domain 512 if SMS-GMSC 517 received routing information in a previous message from SC 520 (shown as event 6). Otherwise, the SMS-GMSC 517 may request routing information from the HSS 515, and then forward the message to PS domain 512 for deliver to UE2 507 (also shown as event 6). PS domain 512 is able to successfully deliver the message to UE2 507 (shown as event 7).

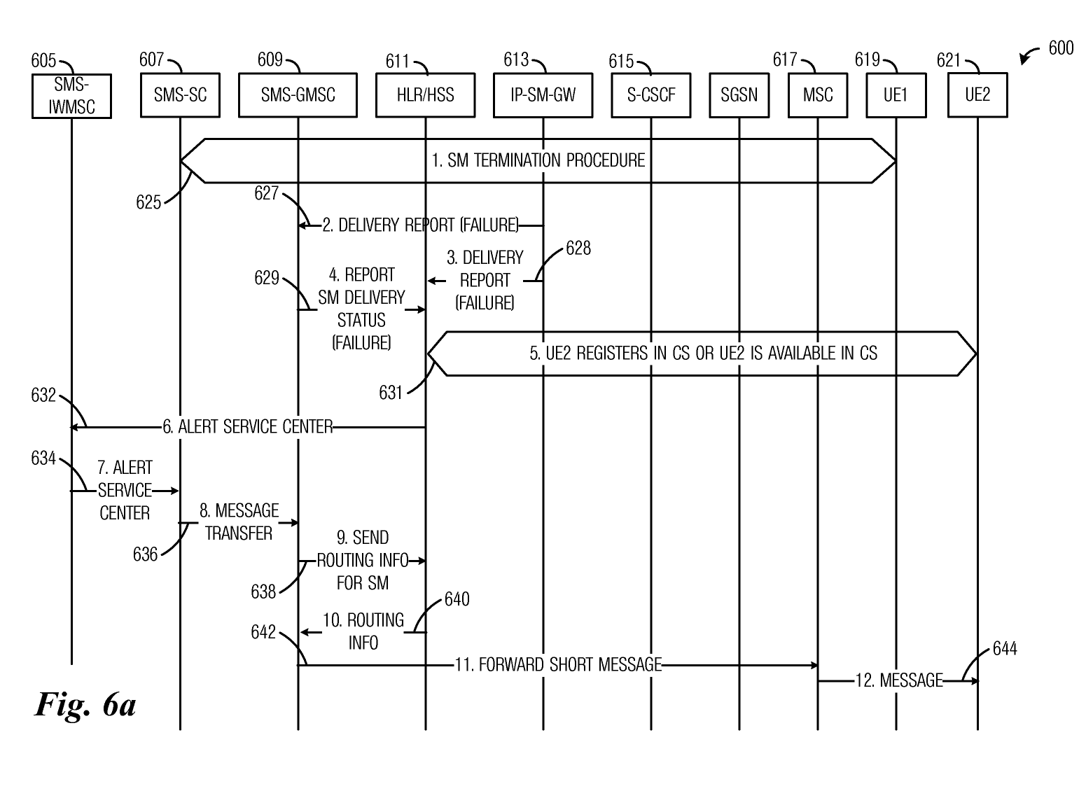

FIG. 6a illustrates a message flow 600 occurring in a communications network for the delivery of a message to an alternate UE of a user operating in a communications network. Message flow 600 illustrates messages exchanged between various entities in the communications network involved in the delivery of a message to an alternate UE of a user. Message flow 600 involves entities: Interworking MSC For Short Message Service (SMS-IWMSC) 605, SMS service center (SMS-SC) 607, Gateway MSC For Short Message Service (SMS-GMSC) 609, HLR/HSS 611, IP-Short-Message-Gateway (IP-SM-GW) 613, serving call session control function (S-CSCF) 615, Mobile Switch Center (MSC) 617, User Equipment 1 (UE1) 619, and User Equipment 2 (UE2) 621.

Message flow 600 may begin with SMS-SC 607, SMS-GMSC 609, HLR/HSS 611, IP-SM-GW 613 and UE1 619 participating in a short message termination procedure (event 625). The short message termination procedure may be a result of a failure in a delivery of a message to UE1 619 in the first domain. The failure in the delivery of the message may be the result of UE1 619 disconnecting from the first domain or otherwise becoming unavailable. Since UE1 619 has disconnected from the first domain, attempts to deliver messages to UE1 619 in the first domain will fail. IP-SM-GW 613 may report to SMS-GMSC 609 that a message deliver attempt to UE1 619 has failed (event 627). Furthermore, IP-SM-GW 613 may report to HLR/HSS 611 that a message deliver attempt to UE1 619 has failed (event 628). SMS-GMSC 609 may also report the failure of the message delivery attempt to HLR/HSS 611 (event 629).

At a later time, an alternate UE of the user (e.g., UE2 621) and HLR/HSS 611 may participate in a CS registration procedure when UE2 621 appears in the communications network or UE2 621 is detected as being available in its domain (event 631). With UE2 621 registered or present in the communications network, HLR/HSS 611 may alert SMS-IWMSC 605 that there is a pending message for the user of UE2 621 (event 633). Furthermore, SMS-IWMSC 605 may in turn alert SMS-SC 607 that UE2 621 is present in the communications network (event 634). SMS-SC 607, which may be storing the pending message, may forward the pending message to SMS-GMSC 609 (event 636).

SMS-GMSC 609 may send to HLR/HSS 611 a request for routing information for the message to UE2 621 (event 638) and HLR/HSS 611 may respond with the routing information (event 640). SMS-GMSC 609 may then forward the message to MSC 617 (event 642). MSC 617 may then send the message to UE2 621 (event 644).

FIG. 6b illustrates a flow diagram of operations 650 occurring in a HSS for the delivery of a message to an alternate UE of a user operating in a communications network. Operations 650 may be indicative of operations occurring in a HSS (or HLR/HSS) of a communications network as a message is delivered to an alternate UE of a user. Operations 650 may occur while the HSS is in a normal operating mode.

Operations 650 may begin with the HSS detecting a failure in the delivery of a message to a first UE that was formerly connected to a first domain (block 655). According to an embodiment, the HSS may detect the failure in the delivery of the message due to a report sent to the HSS from a SMS-GMSC or IP-SM-GW. The report may be sent by the SMS-GMSC or IP-SM-GW after it has attempted to deliver the message to the first UE, but has found that the first UE is no longer operating in the first domain.

The HSS may at a later time detect the presence of a second UE (block 657). According to an embodiment, detecting the presence of the second UE may involve the HSS participating with the second UE in a CS or a PS or an IMS registration procedure or detection of the second UE connected to a domain. The second UE may connect to the communications network via the first domain (the same domain as the first UE) or a second domain that is different from the first domain. The second UE and the HSS may participate in the CS or PS or IMS registration procedure as the second UE enters the communications network.

The HSS may then initiate a redelivery of the message to the second UE (block 659). According to an embodiment, initiating the redelivery of the message may involve the HSS sending updated information about the first UE and second UE to a SMS-IWMSC, such as SMS-IWMSC 605 of FIG. 6a. The updated information may then cause the SMS-IWMSC to attempt to redeliver the message. Wherein after, operations 650 may terminate.

If the user has multiple UEs connected to the communications network, the HSS may select one UE at a time to attempt redelivery of the message. The selection of the UE may be based on domain, UE capability, connection type, connection quality, UE signal strength, UE activity, message delivery history, and so forth. If multiple UEs have common selection values, then the HSS may randomly select from the multiple UEs.

FIG. 6c illustrates a flow diagram of operations 670 occurring in a SMS for the delivery of a message to an alternate UE of a user operating in a communications network. Operations 670 may be indicative of operations occurring in a SMS-GMSC or IP-SM-GW of a communications network as a message is delivered to an alternate UE of a user. Operations 670 may occur while the SMS-GMSC or IP-SM-GW is in a normal operating mode.

Operations 670 may begin with the SMS-GMSC or IP-SM-GW detecting a failure in the delivery of a message to the first UE (block 675). According to an embodiment, the SMS-GMSC or IP-SM-GW may detect the failure based on messages exchanged while the first UE and the SMS-SC is participating in a SM termination procedure, which may be the result of a failed message delivery attempt to the first UE. The SMS-GMSC or IP-SM-GW may then send reports of the delivery failure to a HSS (block 677).

At a later time, when the alternate UE has registered in the communications network or has been otherwise detected, the SMS-GMSC or IP-SM-GW may receive a message transfer that contains the failed message (block 679). Additionally, the message transfer may include information about the alternate UE, such as a number or an identifier of the alternate UE, which domain the alternate UE is operating in, for example, a second domain, which may or may not be the same as the first domain, and/or the address of the second domain where the message is to be routed. The SMS-GMSC or IP-SM-GW may then establish a route to the alternate UE in the second domain (block 681) and forward the message to the alternate UE in the second domain (block 683). Wherein after, operations 670 may terminate.

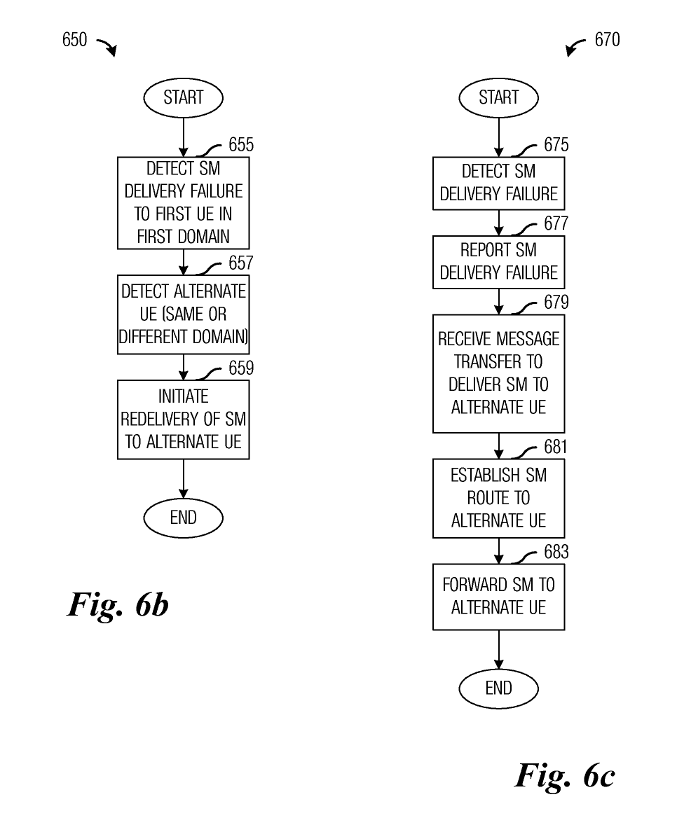

FIG. 7 provides an alternate illustration of a communications device 700. Communications device 700 may be an implementation of a HSS. Communications device 700 may be used to implement various ones of the embodiments discussed herein. As shown in FIG. 7, a receiver 705 is configured to receive information and a transmitter 710 is configured to transmit information. A failure detect unit 720 is configured to detect message delivery failures, a UE detect unit 725 is configured to detect an entry (e.g., registration or reregistration) of a UE in a communications network containing communications device 700, where the UE was previously registered in the communications network. A deliver initiate unit 730 is configured to initiate a delivery of a message that in a failed delivery in a previous delivery attempt. A memory 735 is configured to store information, as well as messages, and so on.

The elements of communications device 700 may be implemented as specific hardware logic blocks. In an alternative, the elements of communications device 700 may be implemented as software executing in a processor, controller, application specific integrated circuit, or so on. In yet another alternative, the elements of communications device 700 may be implemented as a combination of software and/or hardware.

As an example, receiver 705 and transmitter 710 may be implemented as a specific hardware block, while failure detect unit 720, UE detect unit 725, and deliver initiate unit 730 may be software modules executing in a microprocessor (such as processor 715) or a custom circuit or a custom compiled logic array of a field programmable logic array.

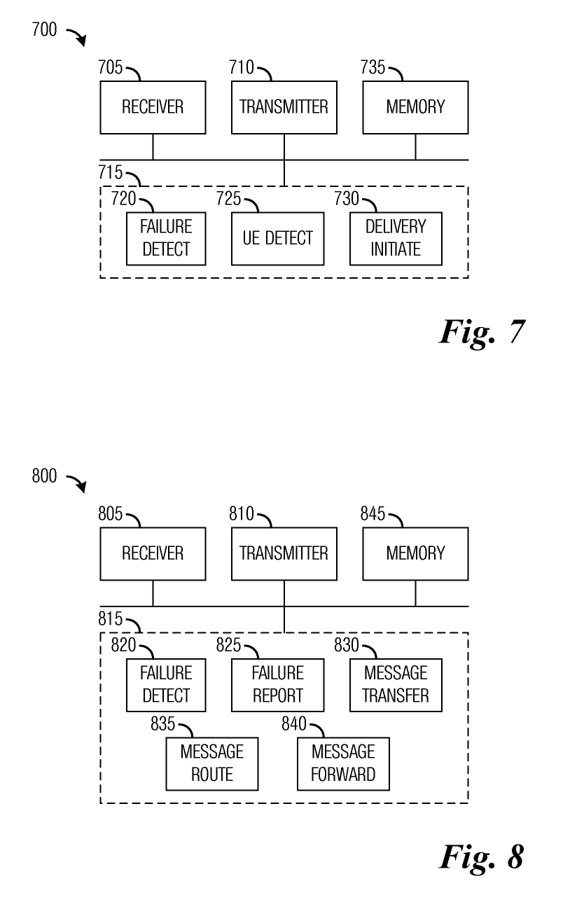

FIG. 8 provides an alternate illustration of a communications device 800. Communications device 800 may be an implementation of a SMS. Communications device 800 may be used to implement various ones of the embodiments discussed herein. As shown in FIG. 8, a receiver 805 is configured to receive information and a transmitter 810 is configured to transmit information. A failure detect unit 820 is configured to detect message delivery failures, a failure report unit 725 is configured to report the failure in the delivery of a message to other network entities in a communications network containing communications device 800. A message transfer unit 830 is configured to receive and process messages that failed in a previous delivery attempt, a message route unit 835 is configured to compute a route path for a delivery of a message to a UE, and a message forward unit 840 is configured to forward messages to entities in the communications network. A memory 845 is configured to store information, as well as messages, and so on.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 805 and transmitter 810 may be implemented as a specific hardware block, while failure detect unit 820, failure report unit 725, message transfer unit 830, message route unit 835, and message forward unit 840 may be software modules executing in a microprocessor (such as processor 815) or a custom circuit or a custom compiled logic array of a field programmable logic array.

The above described embodiments of communications devices 700 and 800 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 4b, 4c, 6b, and 6c—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for communications device operations, the method comprising:
detecting a failure in a delivery of a message to a first recipient device, wherein the first recipient device is unavailable in the first domain;
determining a second recipient device for the message; and
initiating a redelivery of the message to the second recipient device.

2. The method of claim 1, wherein the first recipient device is formerly registered in the first domain.

3. The method of claim 1, wherein detecting a failure in a delivery of a message comprises receiving a message indicating that the delivery of the message failed.

4. The method of claim 1, wherein determining a second recipient device comprises determining that the first recipient device has become reachable in a second domain.

5. The method of claim 4, wherein the first recipient device has registered in the second domain.

6. The method of claim 4, wherein determining that the first recipient device has registered in a second domain comprises participating in a registration procedure with the first recipient device.

7. The method of claim 4, wherein the first domain is different from the second domain.

8. The method of claim 4, wherein initiating a redelivery comprises alerting a service center about the first recipient device in the second domain.

9. The method of claim 8, wherein initiating a redelivery further comprises:
receiving the message; and
forwarding the message based on routing information for the first recipient device in the second domain.

10. The method of claim 1, wherein the first recipient device is used by a user, and wherein determining a second recipient device comprises determining that a second recipient device is available in the communications network, where the second recipient device is used by the user.

11. The method of claim 10, wherein determining that a second recipient device is available comprises participating in a registration procedure with the second recipient device or detecting that the second recipient device is already registered or detecting that the second recipient device becomes reachable.

12. The method of claim 10, wherein initiating a redelivery comprises alerting a service center about the second recipient device.

13. The method of claim 12, wherein initiating a redelivery further comprises:
receiving the message; and
forwarding the message to a mobility controller based on routing information for the second recipient device.

14. A method for communications device operations, the method comprising:
detecting a failure in a delivery of a message to a first recipient device, wherein the first recipient device is unavailable in the first domain;
receiving an alternate message to be delivered to a second recipient device;
establishing a route path to the second recipient device; and
forwarding the alternate message to the second recipient device over the route path.

15. The method of claim 14, wherein detecting a failure in a delivery of a message comprises receiving a message indicating that the delivery of the message failed.

16. The method of claim 14, wherein the second recipient device is the first recipient device registered in a second domain of the communications network, and wherein establishing a route path comprises requesting or receiving routing information from a subscriber server.

17. The method of claim 16, wherein forwarding the alternate message comprises forwarding the alternate message to a network entity where the second recipient device is registered.

18. The method of claim 14, wherein the first recipient device is used by a user, wherein determining a second recipient device comprises determining that a second recipient device is registered in the communications network, where the second recipient device is used by the user, and wherein establishing a route path comprises requesting or receiving routing information from a subscriber server.

19. The method of claim 18, wherein forwarding the alternate message comprises forwarding the alternate message to a mobility controller.

20. The method of claim 14, further comprising reporting the failure.

21. A communications device comprising:
a failure detect unit configured to detect a failure in a delivery of a message to a first recipient device, where the first recipient device is unavailable in the first domain;
a recipient detect unit coupled to the failure detect unit, the recipient detect unit configured to detect a second recipient device for the message; and
a delivery initiate unit coupled to the recipient detect unit, the delivery initiate unit configured to initiate a redelivery of the message to the second recipient device.

22. The communications device of claim 21, wherein the recipient detect unit configured to further detect that the first recipient device has become available in a second domain of the communications network.

23. The communications device of claim 22, wherein the delivery initiate unit initiates the redelivery of the message by alerting a service center regarding the first recipient device in the second domain.

24. The communications device of claim 23, wherein the delivery initiate unit further initiates the redelivery of the message by receiving the message and forwarding the message based on routing information for the first recipient device in the second domain.

25. The communications device of claim 21, wherein the recipient detect unit configured to further detect that a second recipient device is registered in the communications network, and wherein the first recipient device and the second recipient device are used by a user.

26. The communications device of claim 25, wherein the delivery initiate unit initiates the redelivery of the message by alerting a service center regarding the second recipient device.

27. The communications device of claim 26, wherein the delivery initiate unit further initiates the redelivery of the message by receiving the message and forwarding the message based on routing information for the second recipient device.

28. A communications device comprising:
a failure detect unit configured to detect a failure in a delivery of a message to a first recipient device, where the first recipient device is unavailable in the first domain;
a message transfer unit coupled to the failure detect unit, the message transfer unit configured to receive an alternate message to be delivered to a second recipient device;
a message route unit coupled to the message transfer unit, the message route unit configured to establish a route path to the second recipient device; and
a message forward unit coupled to the message route unit and to the message transfer unit, the message forward unit configured to forward the alternate message to the second recipient device over the route path.

29. The communications device of claim 28, wherein the second recipient device is the first recipient device registered in a second domain of the communications network, and wherein the message route unit requests the route path from a subscriber server.

30. The communications device of claim 29, wherein the message forward unit forwards the alternate message to a network entity where the UE is registered.

31. The communications device of claim 28, wherein the second recipient device and the first recipient device are used by a user, and wherein the message route unit requests the route path from a subscriber server.

32. The communications device of claim 31, wherein the message forward unit forwards the alternate message to a mobility controller.

33. The communications device of claim 28, further comprising a failure report unit coupled to the failure detect unit, the failure report unit configured to report the failure to communications devices in the communications network.
